(19) United States
(12) Patent Application Publication
(10) Pub. No.: US 2019/0085180 A1
(43) Pub. Date: Mar. 21, 2019

(54) Water Borne Coating Composition, Use of Such Composition, Method for Coating a Substrate Using Such Composition and Coated Substrates

(71) Applicant: Akzo Nobel Coatings International B.V., Amhem (NL)

(72) Inventors: Zheng Li, Shanghai (CN); Guiguang Chen, Shanghai (CN); Riaz Ahmad Choudhery, Solihull, West Midlands (GB); Ye He, Shanghai (CN); Ling Chen, Shanghai (CN)

(21) Appl. No.: 15/534,127

(22) PCT Filed: Dec. 21, 2015
(86) PCT No.: PCT/EP2015/080768

§ 371 Date: Jun. 8, 2017

(30) Foreign Application Priority Data
Dec. 25, 2014 (CN) PCT/CN2014/094971
May 7, 2015 (EP) 15166754.0

(51) Int. Cl. C09D 5/28; C09D 5/02; C09D 7/40; C09D 129/04; C09D 133/08; C09D 125/14; C09D 123/08; C09D 131/04

(52) U.S. Cl. CPC C09D 5/28; C09D 5/028; C09D 7/70; C09D 5/022; C09D 131/04; C09D 133/08; C09D 125/14; C09D 123/0853; C09D 129/04

(57) ABSTRACT

The present invention is directed to a water borne coating composition. The composition according to the present invention comprises an emulsified binder, wherein the binder is a polymer selected from the group consisting of polymers prepared by emulsion polymerization of unsaturated vinyl, acrylate and/or methacrylate monomers, alkyd, polyurethane, and epoxy, 0.3% to 10% by weight of a second polymer selected from one or more of the group consisting of poly(vinyl alcohol) and water-soluble copolymers having repeat units of vinyl alcohol, wherein, if the second polymer is poly(vinyl alcohol), at least 85 wt % of the second polymer has a number of repeat units not less than 2,000, and 0% to 15% by weight of a cellulose-based filler, based on the total weight of the composition, wherein the weight ratio of second polymer to binder is in the range of from 1:100 to 1:1. The composition maybe used in various applications to form a decorative coating which has special visual and tactile effect.

### FIELD OF THE INVENTION

The present invention relates to water borne coating compositions, specifically to water borne coating compositions for forming coatings with special visual and tactile effect. The present invention further relates to methods for forming fabric-like coatings with the compositions, to coated substrates obtainable by such methods and to use of such compositions for forming a fabric-like coating decorative coating on a substrate.

### BACKGROUND OF THE INVENTION

Coatings with special appearance are required in a wide variety of applications. For instance, they are used in architecture decoration, car interior decoration, as well as in furniture coatings and many other applications. Currently, application tools such as brushes, rollers and sponges are popular ways to create desired visual texture. This approach usually has special requirements for the rheology property of the coating composition system. Visual and/or tactile texture can also be achieved by adding special fillers, for instance sand, polymer bead, fiber, or metallic pigment to the composition. Furthermore, multi-phase systems may be used to create textured coatings such as Marble paints.

Coatings with textile and/or fabric-type texture have been obtained from various coating composition systems and application methods.

WO2005/090491 discloses a composition comprising pre-pigmented spherical aliphatic polyurethane particles and a special application method to paint a substrate bearing a textile, suede, velvety or soft-feel effect. This solution requires at least one completely hiding layer and a semi-opaque/semi-transparent paint layer with different colors, and the final visual texture is created by tools and the polymer particles. EP-A 0352804 discloses textile effect paint with vinyl chloride particles.

WO 03/104540 and WO 2007/000599 disclose a spray-on technology for the composition containing polymeric binder, fibers and solvents to produce a non-woven fabric via spraying. However, the compositions are solvent borne and so have health and safety as well as environmental limitations.

U.S. Pat. No. 3,117,942 discloses a webbed coating prepared from lacquer or enamel compositions containing water-soluble high molecular weight poly(ethylene oxide). The technology is applicable to a wide variety of organic film-forming materials, including especially webbing compositions where normally film-forming water emulsions of latex-based compositions are used. This patent did not discuss the feasibility of fast overlaying of the webbed structure to form a fabric-like coating.

### SUMMARY OF THE INVENTION

It has now been found that water borne coating compositions can be prepared that are suitable for preparing coatings with textile-type visual and tactile texture, with simple application methods under ambient conditions. More in particular, it has been found that aqueous coating compositions that comprise an emulsified binder, i.e. an emulsified film-forming polymer, and a second polymer selected from the group consisting of poly(vinyl alcohol), a water-soluble copolymer having repeat units of vinyl alcohol, and combinations thereof, in a specific ratio of the binder and the second polymer, can provide a textured coating by, for example, spray application. The texture of the resulting coatings arises from the generation of in-flight fibers/threads of polymer (binder and/or second polymer) during spray application under ambient temperatures. The sprayed fibers/threads with low density can either half cover the substrate or fully cover the substrate to achieve fabric-like texture coatings with varieties of visual effects. The coating compositions according to the invention, moreover, have a content of volatile organic compounds (VOC) that is very low or even zero. Therefore, the present invention provides a simple and eco-friendly system and approach to create fabric-like coatings with different visual effects. This is especially important but not limited to applications in architecture decoration, car interior decoration, and furniture coatings.

Accordingly, the invention provides a water borne coating composition comprising:
an emulsified binder, wherein the binder is a polymer selected from the group consisting of polymers prepared by emulsion polymerization of unsaturated vinyl, acrylate and/or methacrylate monomers, alkyd, polyurethane, and epoxy;
0.3% to 10% by weight of a second polymer selected from one or more of the group consisting of poly(vinyl alcohol) and water-soluble copolymers having repeat units of vinyl alcohol, wherein, if the second polymer is poly(vinyl alcohol), at least 85 wt % of the second polymer has a number of repeat units not less than 2,000; and
0% to 15% by weight of a cellulose-based filler;
   based on the total weight of the composition, wherein the weight ratio of second polymer to binder is in the range of from 1:100 to 1:1.

It has been found that in particular by spraying the coating composition according to the invention on a substrate through a spraying nozzle of a particular diameter, fabric-like texture coatings can be obtained.

Accordingly, the invention further provides a method for forming a fabric-like coating on a substrate, which comprises the steps of providing a water borne coating composition as hereinbefore defined and applying the water borne coating composition onto the substrate by spraying the coating composition onto the substrate through a nozzle with an internal diameter of 0.2 to 5.5 mm.

The invention also relates to coated substrates obtainable by such method.

In a still further aspect, the invention relates to use of water borne coating compositions as hereinbefore defined for forming a fabric-like decorative coating on a substrate.

### DETAILED DESCRIPTION OF THE INVENTION

The composition according to the present invention comprises water as liquid carrier medium, an emulsified first polymer (a binder), a second polymer selected from one or more of the group consisting of poly(vinyl alcohol) and water-soluble copolymers having repeat units of vinyl alcohol, and optionally water-insoluble cellulose-based fillers. The composition according to the present invention is highly compatible with most water borne polymer-based decorative coating systems, especially with emulsion paint systems.

The composition according to the present invention comprises a relatively high percentage of emulsified binder, preferably of from 10% to 40% by weight, more preferably of from 15% to 30% by weight of dry binder based on the total weight of the composition. The emulsified binders are selected from the group consisting of latexes prepared from emulsion polymerization of unsaturated vinyl, acrylate and methacrylate monomers, emulsified alkyd, emulsified polyurethane, and emulsified epoxy. The binder thus is a polymer selected from the group consisting of polymers prepared by emulsion polymerization of unsaturated vinyl, acrylate and/or methacrylate monomers, alkyd, polyurethane, and epoxy. The composition may comprise two or more emulsified binders.

The composition further comprises a second polymer selected from the group consisting of poly(vinyl alcohol), water-soluble copolymers having repeat units of vinyl alcohol, and combinations thereof, in an amount in the range of from 0.3 to 10 wt % based on the total weight of the composition. It was found that the presence of the second polymer reduces or avoids atomization, i.e. prevents small liquid droplets from being formed during spray application. The addition of the second polymer was observed to result in the generation of polymer fibers (binder and/or second polymer) during spray application of the coating composition.

The second polymer may be one polymer or a mixture of two or more polymers. The second polymer is selected so that it remains in a soluble state in water at a desired concentration range under a normal atmospheric pressure and a temperature ranging from 0 to 80 degrees Celsius. Moreover, the polymer is selected so that no phase separation occurs after mixing the second polymer with the emulsified binder. The second polymer is preferably selected from those with linear architecture and bearing a flexible backbone. The second polymer may be a homopolymer or a copolymer of two or more monomers. A concentrated polymer aqueous solution rather than a polymer in the solid state is preferred when mixing with the emulsified binder. The second polymer is also preferably selected from those with limited steric hindrance effect from the pendent group. Polymers suitable for use as second polymer in the composition according to the present invention include, but are not limited to, polyvinyl alcohol, water-soluble copolymers consisting of vinyl alcohol repeat units, and other repeat units selected from, but not limited to, ethylene, vinyl butyral, vinyl chloride, acetates such as vinyl acetate, butyl acetate, pentyl acetate, acrylates such as methyl acrylate, vinyl acrylate, butyl acrylate, pentyl acetate, methacrylates such as methyl methacrylate, vinyl methacrylate, butyl methylacrylate, pentyl methylacrylate, acrylamides, ethylene oxide, propyl oxide urethane, other units modified from vinyl alcohol.

When used herein, the term “repeat unit” or “repeating unit” refers to a part of a polymer whose repetition would produce the complete polymer chain (except for the end groups) by linking the repeat units together successively along the chain. The number of repeat units linked together reflects the degree of polymerization of polymers. In copolymers there are two or more types of repeat unit, which may be arranged in alternation, or at random, or in other more complex patterns. It is noted that the number of repeat units of copolymers, or the degree of polymerization of polymers mentioned throughout the present invention, is meant to be the total number of different types of repeat units.

The degree of polymerization of the second polymer may affect the performance of the resulting coating composition. Preferably, the second polymer has a high number of repeat units. In case the second polymer is poly(vinyl alcohol), at least 85% by weight of the polymer molecules have a number of repeat units not less than 2,000, preferably not less than 2,200, more preferably not less than 2,400, even more preferably not less than 2,600 mm. In some embodiments, at least 95% or substantially all of the poly(vinyl alcohol) has a number of repeat units not less than 2,400. In case the second polymer is a copolymer, both the degree of polymerization and the mole percentage of hydrophilic unit may affect the performance of the resulting composition. For instance, for poly(vinyl acetate-co-vinyl alcohol), the vinyl alcohol repeat units may account for not less than 65% by mole percentage, preferably not less than 70% by mole percentage, more preferably not less than 75% by mole percentage, and even more preferably not less than 80% by mole percentage. The number of repeat units of copolymers is highly dependent on the mole percentage of hydrophilic units. For instance, for poly(vinyl acetate-co-vinyl alcohol), preferably at least 85% by weight of the second polymer has a number of repeat units of not less than 2,000, more preferably not less than 2,100, still more preferably not less than 2,400, and even still more preferably not less than 2,600 mm. In some embodiments, at least 95% or substantially all of the second polymer has a number of repeat units of not less than 2,500.

In compositions according to the present invention, the amount of second polymer to be added is highly dependent on the property of the second polymer, including molecular weight, flexibility, associative ability, pendent groups therefrom, and so on. It was observed that the addition of second polymer may increase the viscosity of the system. A high viscosity of a composition generally makes it difficult to spray the composition. As a result, the amount of second polymer in the coating composition is not more than 10 wt %, preferably not more than 8%, more preferably not more than 6%, and even more preferably not more than 5.5%, based on the total weight of the coating composition. Preferably, the weight percentage of second polymer is in the range from 2% to 8%, more preferably in the range from 2.5% to 6%, and even more preferably in the range from 3% to 5% based on the total weight of the coating composition.

Cellulose-based fillers are preferably added to the composition according to the present invention. Such fillers contribute to the tactile texture of the resulting coatings. Generally, the cellulose-based fillers are added in an amount of not more than 15 wt %, preferably not more than 10 wt %, and more preferably not more than 5 wt %, based on the total weight of the coating composition. In some embodiments wherein the substrate is required to be half covered with the sprayed fibers (shown in FIG. 1a), the cellulose-based fillers may be added in an amount of not more than 1 wt %, preferably not more than 0.05 wt %. Such half-covered substrates may even be prepared by applying a coating composition that is free of cellulose-based fillers. In some embodiments wherein the substrate is required to be fully covered with the sprayed fibers (shown in FIG. 1b), the cellulose-based fillers may be added in an amount of not less than 0.03%, preferably not less than 0.05%, more preferably not less than 0.5%, and even more preferably not less than 2%, based on the total weight of the composition. Preferably, the coating composition comprises in the range of from 2 to 5 wt % of cellulose-based fillers.

The cellulose-based fillers are required to be well dispersed in the composition. These cellulose-based fillers may be particulate or fibrous cellulose-based fillers, preferably selected from, but not limited to, the group consisting of microcrystalline cellulose, regenerated cellulose, and lignocellulose. Suitable lignocellulose may for example be plant fibers or wood fibers. It is not necessary to use only one type of cellulose-based filler in the composition. Mixtures of more than one type of cellulose-based filler may be used in the composition according to the present invention. The particle size of the cellulose-based fillers in the composition should not be too large, since a composition comprising cellulose-based fillers with large particle sizes cannot be sprayed easily, and may cause blockage in the nozzle. Preferably, in case of fibrous cellulose-based fillers at least 85% by weight of the fillers have a length of not more than 5 mm, more preferably not more than 2 mm, still more preferably not more than 1 mm, even more preferably not more than 0.7 mm, and most preferably not more than 0.2 mm. In some embodiments, at least 95% or substantially all of the fillers have a length of not more than 2 mm.

The weight ratio of the second polymer to the binder is within the range of 1:100 to 1:1. Preferably, the weight ratio of second polymer to binder is within the range of 1:50 to 1:2, more preferably within the range of 1:40 to 1:3, and even more preferably within the range of 1:10 to 1:4.

The coating composition according to the present invention is a waterborne coating composition, and water is thus the liquid carrier medium for the emulsified binder and for the second polymer. The composition preferably comprises in the range of from 30% to 80% by weight water, based on the total weight of the composition. The high boiling point of water may result in fusion of the sprayed fibers —i.e. the fibers that are formed upon spraying—and thus a film that has low texture may be formed. This phenomenon especially occurs in coating composition systems with low solid contents. To improve the texture, cellulose-based fillers are preferably added to the coating composition of the present invention. It has been observed that the cellulose-based fillers may exhibit two functions in the coating composition according to the present invention: 1) keep the generated fibers from collapsing by virtue of the low density of these cellulose-based fillers as compared with conventional inorganic powder fillers; and 2) help the overlaying of generated fibers and avoid fusion of such fibers because of the high water retention ability of these cellulose-based fillers.

In an embodiment of the present invention, fibers/threads with controllable size are generated through the nozzle of a sprayer at ambient condition. The fibers/threads are attached to a substrate, to form a coating with fabric-like effects. The diameter of the generated fibers was observed to be varied in the range from micrometers to thousands of micrometers. The density of fibers/threads on the substrate increased steadily along with the application process being performed continuously, and meanwhile, the fibers/threads were overlaid one with the other such that the thickness of the resulting coating film was increased gradually. The diameter, density, regularity, and directionality of fibers on the substrate determined and/or characterized the final appearance of the coating. As an example, two patterns were obtained with a different density of fibers/threads sprayed onto the substrate, which are depicted in FIGS. 1a and 1b. The pattern in FIG. 1a is mainly achieved with low density and uniform directional fibers, as well as a completed hiding basecoat which plays a critical role in the final appearance. The pattern in FIG. 1b requires the fibers to fully cover the substrate and with a certain thickness. Generally, the resulting appearance of the coating according to the present invention is mainly determined by the generated fibers/threads. Furthermore, a warm and soft tactile texture was obtained when a certain amount of lignocellulose or plant fibers was added to the composition.

FIGS. 2a and 2b show images of fibers overlaying in typical fabric-like coatings obtained from the present invention, taken by light microscopy and scanning electron microscopy, respectively.

The coating composition according to the present invention may further comprise inorganic fillers, extenders and additives (including coalescent agents, surfactants, dispersants, biocides, neutralizing agents, defoaming agents, and anti-freeze agents) used in conventional coating formulations.

For different colors of the coating composition, dyed cellulose-based fillers, in particular dyed cellulose fibers, may be used, or pigments and/or dyes can be added to the coating composition.

In another aspect of the invention, use of the water borne coating composition according to the present invention is provided. The water borne coating composition may be used to form a decorative coating on a substrate, and therefore relevant articles coated with a decorative coating are also provided in the present invention.

Specifically, the coating composition according to the present invention may be used to form a decorative coating on walls, floors, car interiors or other surfaces to provide the relevant coated articles with special visual and tactile effects. The surface may be of any suitable material such as wood, plastic, metal, paper, or fabric.

In yet another aspect of the invention, a method for forming a decorative coating on a substrate is provided. In the method according to the invention the water borne coating composition according to the present invention is sprayed onto a substrate with a spraying device with a nozzle with an internal diameter of 0.1 to 5.5 mm, preferably 0.5 to 2 mm. A multi-nozzle sprayer can improve the efficiency and richness of the visual texture throughout the application process.

It has been observed that certain interacting factors may affect the final appearance of the fabric-like coating produced according to the method of the present invention. The velocity and uniformity of the sprayer movement during the application may determine the fabric density and regularity of the fibers. Specifically, moving the sprayer at a relatively low speed during application of the coating composition results in partial fusion of the resulting fibers/threads. This is mainly because of the faster overlaying of the generated fibers/threads, which leads to an undesired continuous film rather than fabric-like coatings formed on the substrate. On the other hand, fast movement of the sprayer during application of the coating composition was found to result in low density of fibers/threads formed on the substrate. In addition, the regularity of the distribution of fibers/threads formed on the substrate was found to be greatly affected by the uniformity of the sprayer movement during application of the coating composition. One of ordinary skill in the art will understand that the regularity of the resulting coating may be further improved by careful re-spraying.

According to the present invention, during application of the coating composition onto a substrate, the distance from the application tools such as the nozzles of a sprayer to the substrate is required to be within a desirable range, to control the differences in appearance of the resulting fabric-like coatings. Preferably, the distance between the nozzle of the application sprayer and the substrate surface is less than 100 cm, more preferably less than 50 cm, even more preferably within the range from 15 cm to 30 cm.

### DESCRIPTION OF DRAWINGS

The above and other objectives, features, and advantages of the present invention will become more apparent to those of ordinary skill in the art by being described in embodiments thereof with reference to the accompanying drawings.

FIG. 1a shows the pattern achieved with low density and uniform directional fibers as well as a completely hiding basecoat which plays a critical role in the final appearance.

FIG. 1b shows the pattern of the fibers fully covering the substrate and with a certain thickness.

FIGS. 2a and 2b show images of fibers overlaying in typical fabric-like coatings obtained from the present invention, taken by light microscopy and scanning electron microscopy, respectively.

### EXAMPLES

The following examples are offered to illustrate, but not to limit the claimed invention.

### Example 1

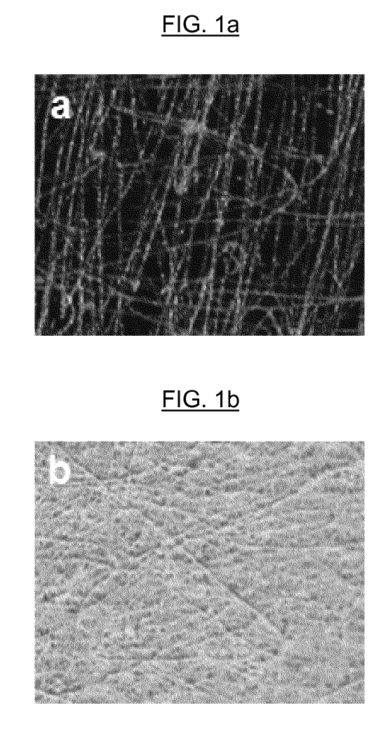

40 grams of an aqueous binder emulsion (PRIMAL SF-500, ex. Dow Chemical Company,—solid binder content approximately 50 wt %), 40 grams poly(vinyl alcohol) aqueous solution with solid content of 10% (NH-26, available from Nippon Gohsei), 4 grams plant fibers (lignocellulose fibers), 12.4 grams TiO₂ slurry (Dupont A706, solid content 70 wt %), 0.67 grams Coasol 290 (Eastman Chemical Company), 1 gram polypropylene glycol, 1 g Vantex TA 496 (Taminco), and pigments were mixed at room temperature for 20 minutes. The composition is sprayed on a cement board with an air-assisted sprayer with a nozzle of 0.7 mm. A photo of the fabric coating formed taken by a digital camera is shown in FIG. 1b.

### Example 2

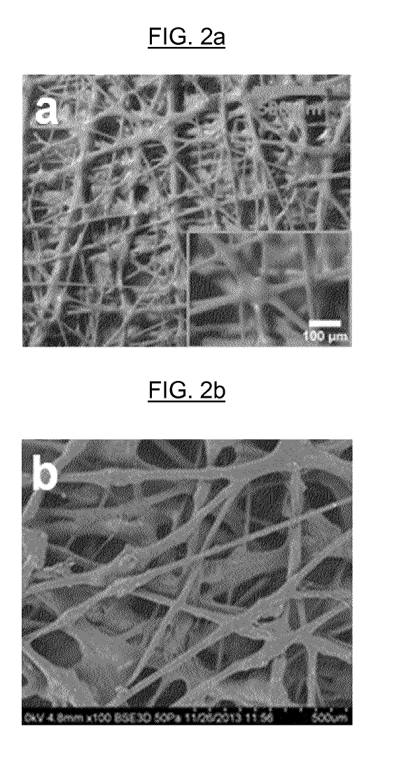

40 grams of an aqueous binder (vinyl acetate/ethylene) emulsion (EcoVAE 1603, ex. Celanese—solid binder content 53 wt %), 50 grams poly(vinyl alcohol)-co-poly(vinyl acetate) aqueous solution with solid content of 10% (GH-23, available from Nippon Gohsei), 4 grams wood fibers with a length smaller than 150 μm, 6 grams TiO₂ slurry (solid content 70 wt %), 5 grams CaCO₃, 0.67 grams Coasol 290 (Eastman Chemical Company), 1 gram polypropylene glycol, 1 g Vantex TA 496 (Taminco), 2 grams water, and pigments were mixed at room temperature for 20 minutes. The composition is sprayed on a cement board with an air-assisted sprayer with a nozzle of 1.0 mm. A light microscope image of the coating formed is shown in FIG. 2a.

### Example 3

40 grams of an aqueous binder emulsion (Acronal® Eco 702 ap, ex. BASF—solid binder content 50 wt %), 30 grams poly(vinyl alcohol)-co-poly(vinyl acetate) aqueous solution with solid content of 10% (NH-26, available from Nippon Gohsei), and 2 grams gold pearlescent pigment (Iriodin 9307, Merck) were mixed at room temperature for 20 minutes. The composition is sprayed on a plastic board with an air-assisted sprayer with a nozzle of 0.7 mm. A photo of the fabric coating formed taken by a digital camera is shown in FIG. 1a.

1. A water borne coating composition, comprising:
an emulsified binder, wherein the binder is a polymer selected from the group consisting of polymers prepared by emulsion polymerization of unsaturated vinyl, acrylate and/or methacrylate monomers, alkyd, polyurethane, and epoxy;
0.3% to 10% by weight of a second polymer selected from one or more of the group consisting of poly(vinyl alcohol) and water-soluble copolymers having repeat units of vinyl alcohol, wherein, if the second polymer is poly(vinyl alcohol), at least 85 wt % of the second polymer has a number of repeat units not less than 2,000; and
0.03% to 15% by weight of a cellulose-based filler;
based on the total weight of the composition, wherein the weight ratio of second polymer to binder is in the range of from 1:100 to 1:1.

2. The water borne coating composition according to claim 1, wherein the weight percentage of the second polymer is within the range from 0.3% to 6% by weight based on the total weight of the composition.

3. The water borne coating composition according to claim 1, wherein the second polymer is a poly(vinyl alcohol) which has a number of repeat units of not less than 2,000.

4. The water borne coating composition according to claim 1, wherein the second polymer is a poly(vinyl acetate-co-vinyl alcohol) with a mole percentage of vinyl alcohol of less than 70%, and a number of repeat units of vinyl acetate and vinyl alcohol of at least 2,000.

5. The water borne coating composition according to claim 1, wherein the cellulose-based filler is selected from the group consisting of microcrystalline cellulose, regenerated cellulose, and lignocellulose.

6. The water borne coating composition according to claim 1, wherein the cellulose-based filler is a fibrous cellulose-based filler.

7. The water borne coating composition according to claim 1, wherein the weight percentage of the cellulose-based filler is not less than 0.5%, based on the total weight of the composition.

8. The water borne coating composition according to claim 6, wherein the weight percentage of the cellulose-based filler is within the range from 2% to 5%, based on the total weight of the composition.

9. The water borne coating composition according to claim 1, wherein the weight percentage of the binder is within the range from 10% to 40% based on the total weight of the composition.

10. The water borne coating composition according to claim 1, wherein the weight ratio of the second polymer to the binder is within the range from 1:50 to 1:2.

11. The water borne coating composition according to claim 1, which further comprises components selected from the group consisting of pigments, dyes, inorganic fillers, extenders, coalescent agents, surfactants, dispersants, biocides, neutralizing agents, defoaming agents, and anti-freeze agents.

12. A method for forming a fabric-like coating on a substrate, which comprises,
providing a water borne coating composition according to claim 1;
applying the water borne coating composition onto the substrate by spraying the coating composition onto the substrate through a nozzle with an internal diameter of 0.2 to 5.5 mm.

13. The method according to claim 12, wherein the distance from the substrate to the nozzle is kept within the range from 15 cm to 30 cm.

14. (canceled)

15. The coated substrate obtained by a method according to claim 12.

16. The water borne coating composition according to claim 9, wherein the weight percentage of the binder is within the range from 15% to 30% based on the total weight of the composition.

17. The water borne coating composition according to claim 10, wherein the weight ratio of the second polymer to the binder is within the range from 1:40 to 1:3.

18. The water borne coating composition according to claim 10, wherein the weight ratio of the second polymer to the binder is within the range from 1:10 to 1:4.
